(19) United States
(12) Patent Application Publication
(10) Pub. No.: US 2016/0132653 A1
(43) Pub. Date: May 12, 2016

(54) METHOD AND SYSTEM FOR PROCESSING CLINICAL DATA

(71) Applicant: FIGMD, Inc., Hanover Part, IL (US)

(72) Inventor: Sanket BARALAY, Hanover Part, IL (US)

(21) Appl. No.: 14/934,432

(22) Filed: Nov. 6, 2015

Related U.S. Application Data
(60) Provisional application No. 62/078,249, filed on Nov. 11, 2014.

(51) Int. Cl. G06F 19/00

(52) U.S. Cl. CPC G06F 19/345; G06F 19/322; G06F 19/363; G06F 19/327

(57) ABSTRACT

Embodiments provide a method, system and non-transitory computer medium for processing clinical data. In particular, the method comprises configuring at least one processor and at least one memory including computer program instructions to perform the steps of:
receiving an identity of a patient;
conducting a patient consultation session using a point of care computing device, the patient consultation session comprising:
transmitting the identity of the patient to a database adapted to store clinical data, the clinical data comprising at least data corresponding to a clinical intervention program;
receiving first data relating to said clinical intervention program for the patient from the database;
outputting the first data to a display of the point of care computing device; and
determining second data indicative of an action taken in response to the outputting of the data, wherein the second data is for transmission to the database.

### CROSS REFERENCE TO RELATED APPLICATIONS

This application claims the benefit under 35 U.S.C. §119(e) of U.S. Provisional Patent Application No. 62/078,249, filed Nov. 11, 2014, the entire content of which is incorporated herein by reference.

### BACKGROUND OF THE INVENTION

1. Field of the Invention

Embodiments of the present disclosure relate to methods, apparatus and computer software for processing clinical data.

2. Description of the Related Technology

When a patient visits a medical practice, details of the visit are typically stored in a medical record. The details may for example include diagnoses determined by a doctor, or prescribed courses of treatment. The medical record thus may comprise a medical history of the patient. The medical record may for example be stored on a database of the practice in question, or on a central database which amalgamates data from multiple practices.

It is frequently desirable for a doctor to access medical data of patients. For example, a doctor's interpretation of a patient's symptoms, or a doctor's selection of an appropriate treatment, may vary depending on details of the patient's medical history.

Medical data are also frequently used to analyze the performance of a doctor or of a medical practice. Analysis of this type is often based on clinical quality measures, which may for example be expressed as the proportion of patients with a given diagnosis who were prescribed a given best-practice treatment. Should the clinical quality measures of a doctor or practice fall below a threshold value, an action may be taken such as flagging the doctor or practice for further review.

In known systems, medical data are recorded by a medical practitioner during or after a patient visit. Monitors of clinical quality may then request such data for analysis at periodic intervals, for example quarterly. The practice may be required to collect and submit the data, or doctors may be required to individually submit data relating to their own patients. Recording and submitting clinical data presents a substantial burden on the time of medical practitioners and practice administrators.

Known systems for clinical quality measurement thus involve passive analysis of clinical data after it has been collected, for example at the aforementioned periodic intervals. Although doctors may be provided with reports detailing their performance as compared with clinical best practices, such best practices are typically not readily available to doctors during a patient consultation session and it is thus not simple for doctors to base their actions on such best practices.

Consequently, there is a need for a system which allows more efficient entry of clinical data and which allows real-time analysis of such data during a patient consultation session.

### SUMMARY

Embodiments are concerned with a method, apparatus and computer software for processing clinical data according to the appended claims. According to a first aspect of the present disclosure, there is provided a method of processing clinical data, the method may comprise configuring at least one processor and at least one memory including computer program instructions to perform the steps of:

receiving an identity of a patient;

conducting a patient consultation session using a point of care computing device, the patient consultation session comprising:
transmitting the identity of the patient to a database adapted to store clinical data, the clinical data comprising at least data corresponding to a clinical intervention program;
receiving first data relating to a said clinical intervention program for the patient from the database;
outputting the first data to a display of the point of care computing device; and
determining second data indicative of an action taken in response to the outputting of the data, wherein the second data is for transmission to the database.

As a result, a doctor may be provided with first data corresponding to a patient during a consultation session with that patient. Patient care is thus improved by allowing such data to be immediately accessible to the doctor, who is able to consider the data when deciding an appropriate action to take. Details of said action taken in response to the first data can then be efficiently provided to the database, ensuring that the data stored on the database accurately reflects the outcome of the consultation session.

The method may further comprise identifying the patient by a facial recognition algorithm. This allows the patient identity to be quickly and efficiently provided to the database.

In an embodiment, the facial recognition algorithm is performed by the point of care computing device on a digital image of the patient, the digital image may be captured by a camera operatively connected to or contained within the point of care computing device.

In a further embodiment, the point of care computing device is a wearable computing device. The device may be worn by the doctor conducting the consultation session.

In one arrangement, the first data is output as human-comprehensible speech. This allows the doctor to receive the first data during the consultation session in an easily comprehensible form, without requiring access to a screen.

In some embodiments, the determining the second data may comprise:

recording input comprising human speech including information;

encoding the recorded human speech;

inputting the encoded human speech to a speech recognition algorithm;

executing the speech recognition algorithm, whereby to generate an output based on the recorded human speech; and

generating the second data from the output of the speech recognition algorithm.

Consequently, the doctor or another healthcare professional may efficiently record details of the action taken in the consultation session by speaking, for example into a microphone connected to the point of care computing device. This has the effect of reducing the amount of time that the doctor spends recording medical data.

According to some arrangements, the clinical intervention program may comprise a recommended medical intervention selected according to clinical quality measures. This improves the quality of care as the doctor may proactively use the clinical quality measures to inform the decisions taken regarding the patient's treatment.

Preferably in such arrangements, the second data may comprise at least an indication of whether the recommended medical intervention was followed. It is thus ensured that the data on the database reflects the outcome of the consultation session. This also allows it to be noted if a doctor does not follow the recommended medical intervention, after which the doctor may be required to justify such a decision.

In a preferred embodiment, the method includes configuring the point of care computing device to output a request for confirmation of whether the recommended medical intervention was followed, the request may be issued subsequent to outputting the first data. The confirmation may, for example, be entered by typing on a keyboard or by speaking into a microphone, the speech may be processed by a speech recognition algorithm. In such a manner, the database may be efficiently updated with data indicating whether the recommended intervention was followed.

Further features and advantages of the disclosure will become apparent from the following description of preferred embodiments of the invention, given by way of example only, which is made with reference to the accompanying drawings.

### BRIEF DESCRIPTION OF THE DRAWINGS

FIG. 1 shows a system architecture within which embodiments of the present disclosure may be practiced.

FIG. 2 shows a method for transmitting a patient identity to a database and receiving clinical corresponding to that patient. Data is then sent to the database indicating an action taken in response.

FIG. 3 shows a method for checking whether clinical data corresponding to the patient is stored on the database and, if such data is stored, retrieving such data from the database. Data is then sent to the database indicating an action taken in response.

### DETAILED DESCRIPTION OF CERTAIN INVENTIVE EMBODIMENTS

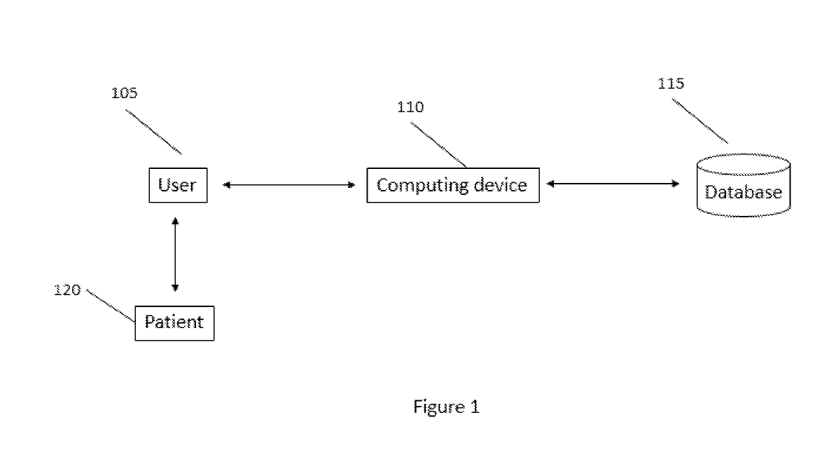

A system architecture according to some embodiments of the present disclosure is shown in FIG. 1, which depicts a user 105 using a point of care computing device 110, which is connected to a database 115 adapted to store clinical data. The user 105 is typically a doctor or other medical practitioner, conducting a patient consultation session with a patient 120. The session may be held in person, for example in a surgery, or remotely, for example by telephone.

The point of care computing device 110 may be a wearable computer device, such as Google Glass®. It may alternatively be a portable device such as a laptop or tablet computer, or a fixed device such as a desktop PC. The database 115 may be stored on a practice EMR (Electronic Medical Records) server, also known as a practice EHR (Electronic Health Records) server. Such servers are typically utilized by medical practices to store clinical data of their patients. In other embodiments, the database 115 may be stored on a central database which amalgamates data from servers of multiple individual practices, for example as described in US Provision Application 62/049,012, herein incorporated by reference. Such embodiments may allow a more comprehensive view of a patient's medical history to be considered when determining a suitable course of action. For example, some such embodiments allow a doctor to take into account elements of a patient's medical history which were administered at a different practice, such as prescriptions or diagnoses from another doctor, when deciding on a course of action. These may affect the best practices of the doctor in question. As an example, a diabetes specialist may wish to take into account the ophthalmology results of a diabetic patient when deciding on a suitable prescription.

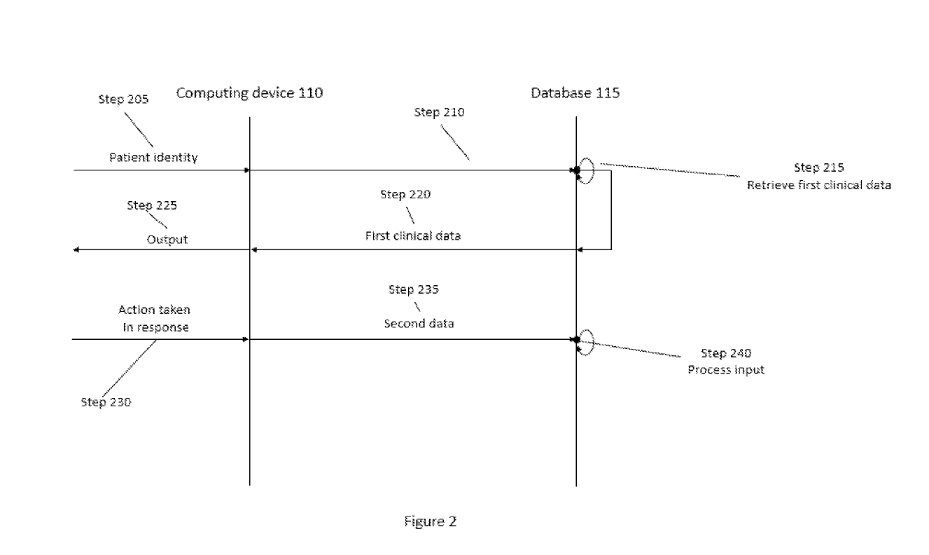

A method of delivering and collecting clinical data according to some embodiments will now be described with reference to FIG. 2. A patient identity is received (step 205) at a point of care computing device 110. The patient 120 may be identified by the user 105 entering the name of the patient 120 into the computing device 110, for example by typing on a keyboard or by speaking into a microphone with the spoken words analyzed using a speech recognition algorithm.

According to other aspects of the disclosure, the patient 120 may be identified by a facial recognition algorithm. For example, the computing device 110 may include or be connected to a camera. An image of the patient 120 captured by the camera may then be analyzed using facial recognition algorithms, known to those skilled in the art, to provide the patient identity. In such aspects of the disclosure, the facial recognition algorithm may be performed by the computing device 110. Alternatively, the image of the patient 120 may be transmitted to a device such as a server remote from the computing device 110, following which the facial recognition algorithm may be performed by the remote device. The remote device may for example be a server located in the practice, or a central server connected to multiple practices. This would potentially allow the algorithm to access a database of faces which would be too large to feasibly store in the computing device 110. The remote device may, in some embodiments, be a server on which the database 115 is stored.

According to further aspects of the disclosure, the patient 120 may be identified by a visual code such as a QR code, which may be stored for example on a mobile device or an identification card possessed by the patient 120. In such aspects, the code is presented by the patient 120 to the computing device 110, or to a scanner connected to the computing device 110. The computing device 110 typically then transmits the code to a remote server as described above. The remote server identifies the patient as being associated with that code.

During the patient consultation session, the patient identity is provided to the database 115 (step 210). Clinical data stored by the database may comprise at least data corresponding to a clinical intervention program. An intervention may be a prescription of medication, surgery, or any other medical treatment. For example, the patient's medical history may be analyzed and a recommended medical intervention may be selected according to clinical quality measures. Such quality measures typically indicate that a patient with a given profile of diagnoses should be prescribed a certain medical intervention.

First clinical data relating to a said clinical intervention program for the patient are retrieved from the database 115 (step 215) and transmitted to the computing device 110 (step 220). The first clinical data may, in some embodiments, comprise a recommended medical intervention, based on the patient's medical history as described above.

The first clinical data may also comprise relevant details of the patient's medical history. These details may be selected based on context. The context may include the clinical specialty of the user 105. For example, if the user 105 is a cardiologist, the first clinical data may comprise recent cardiology data for the patient 220. As another example, the context may include the professional role of the user 105, for example “doctor”, “nurse”, “technician”, or “radiologist”. The context may include the clinical setting, examples of which include “out-patient department”, “in-patient department”, “laboratory” and “imaging center”. In a further example, the context may include the extent to which the patient 120 has progressed through an episode of care. As an example of such an episode of care, the patient 120 may progress from an initial diagnosis phase to an intervention phase, followed by evaluation of the efficacy of the intervention and potentially a further intervention phase.

In some embodiments, the context includes a combination of factors such as those described above. As such, the first clinical data may comprise details of the patient's 120 medical records identified as relevant to the user 105, taking into account for example the user's 105 clinical specialty and role, as well as the clinical setting and the progression of the patient 120 through the episode of care.

The first clinical data may be generated by processing data in the database, for example in embodiments in which the first clinical data comprises a recommended medical intervention selected based on medical record data stored in the database. Such processing may be performed by a clinical server on which the database is stored, or by a different server. For example, the data may be stored on a central database which amalgamates data from multiple practices; data comprising a patient's medical records may then be transmitted to a server located in the medical practice in question where it may be processed to produce the first clinical data. In alternative embodiments, such processing may be performed in the computing device 110.

The first clinical data is then output (step 225) to a display of the point of care computing device 110. For example, if the device 110 is a tablet computer, the first clinical data, which may comprise for example a recommended medical intervention as described above, may be displayed on the screen. As another example, if the device 110 is a wearable device such as Google Glass®, the first clinical data may be displayed to the user 105 using the head-mounted display of the device. In a third example, the first clinical data may be output as synthesized human-comprehensible speech.

Subsequent to outputting the first clinical data (step 225), second data are determined (step 230) indicative of an action taken in response to the outputting of the first clinical data.

The second data are then transmitted to the database (step 235), where they are processed for storing in the database (step 240). This may typically comprise updating the patient's medical records to reflect the outcome of the consultation session.

In some embodiments, the second data comprise an indication of whether a recommended medical intervention was followed. For example, a recommended treatment may be output to the doctor (step 225). The doctor may then enter data indicating whether they decided to follow this recommended course of action. This may for example be entered by typing on a keyboard, by selection of graphical user interface elements displayed on a touchscreen, or by voice recognition. In embodiments in which the data are entered by voice recognition, this may comprise recording the doctor's speech, where the speech includes an indication of whether the doctor followed the course of action. The computing device 110 may then perform a speech recognition algorithm on the recording, and produce the second data from the output of this algorithm. Alternatively, the recording may be transmitted to a server which performs a speech recognition on the recording, generating the second data. The second data may then be transmitted to the computing device 110 for transmission to the database 115. The transmission to the database (step 235) may be preceded by a confirmation step in which the doctor may confirm that the second data accurately reflects the speech. In other embodiments, the server may store the data directly in the database 115.

The input of the indication of whether the recommended medical intervention was followed may preferably be received in response to a request for confirmation of whether the recommended intervention was followed, this request may be issued subsequent to the outputting the first data. In other words, after outputting a recommended course of action to the doctor, the doctor may be prompted to indicate whether this course of action was followed. This request for confirmation may preferably be issued to the doctor by the computing device 110, following which the doctor may input data to the computing device 110 indicating whether the intervention was followed. The request for confirmation may for example be issued during or immediately subsequent to the consultation session, or it may be issued at a later time, for example at the end of the day.

The doctor may also provide further details regarding details of the consultation session, such as exact doses of medication prescribed. Alternatively, placeholder entries may be entered in the database for such further details, which may then be provided later, for example by a nurse.

The patient 120 may not have previously attended the practice. In prior art systems, in such a situation the medical records of the patient 120 would typically not be immediately available to the doctor, and would have to be sent to the practice from a previous practice attended by the patient.

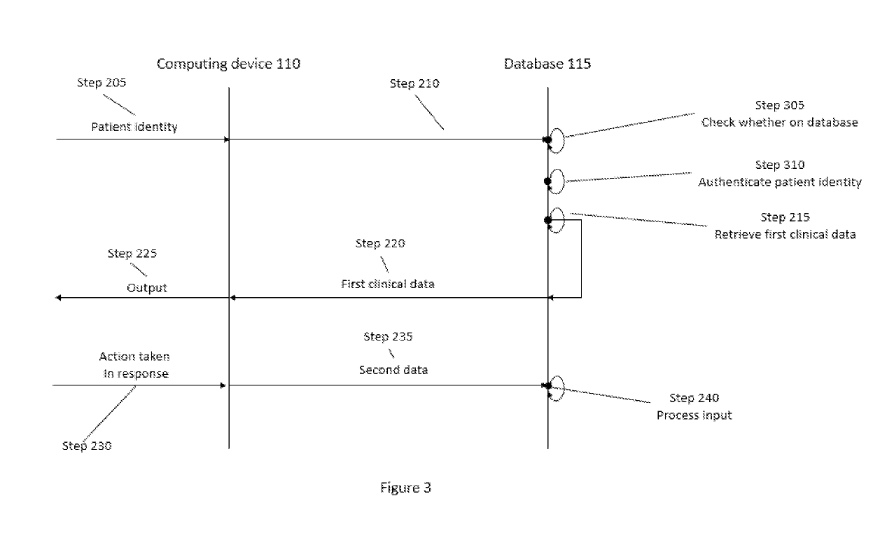

A method for providing clinical data such as medical records to a doctor when the patient has not previously attended the practice, according to some embodiments of the present disclosure, will now be described with reference to FIG. 3. In such embodiments, the database 115 is a central database comprising clinical data from a plurality of practices. If the patient 120 has previously attended one or more of the plurality of practices, clinical data such as the medical records of the patient 120 would be stored in the database 115. During the patient consultation session, the patient identity is provided to the computing device 110 (step 205) as described above. The computing device transmits the patient identity to the database 115 (step 210), where it is determined whether clinical data corresponding to the patient are stored on the database (step 305) and the patient identity is authenticated (step 310). Authentication may be performed by, for example, requiring the patient to submit personal information such as their date of birth or the details of previous practices at which they were registered. The personal information would then be checked against data stored on the database 115. Alternatively, the authentication information may comprise user name and password, which were provisioned to the user by the central repository via the practice of which the user was previously a patient.

First clinical data relating to a clinical intervention program for the patient are retrieved from the database (step 215) and transmitted to the computing device 110 (step 220). The first clinical data may for example comprise details of the patient's medical history; the first clinical data may alternatively comprise the complete medical records of the patient. Such clinical data may be transferred between practices and/or databases using a secure protocol such as the DIRECT protocol.

The first clinical data is then output (step 225) to a display of the point of care computing device 110. The first clinical data may also be transmitted to a database associated with the medical practice, such as a database on which details of patients of the practice are stored. The doctor is thus able to immediately take the first clinical data, for example the patient's medical history, into account when deciding an appropriate action, such as prescribing a treatment. Subsequent to outputting the first clinical data (step 225), second data are determined (step 230) indicative of said action.

The second data are then transmitted to the database (step 235), where they are processed for storing in the database (step 240). This may typically comprise updating the patient's medical records to reflect the outcome of the consultation session, which may for example comprise the action taken by the doctor.

The above described method includes real time reporting to the doctor of recommended medical interventions, such as those given by clinical quality measures. The method also includes real time reporting to the database of the actions performed by the doctor, and whether they matched the actions recommended by clinical quality measures. In this manner, a doctor may be provided with quality measures during a consultation with a patient and may use these to inform their actions, as opposed to merely comparing their actions with quality measures after the fact. The method also lessens the doctor's work burden by, for example, requiring only a yes/no response as to whether an action was followed, instead of requiring the doctor to spend significant time writing up notes.

It should be noted that the use of the word “steps” in this disclosure does not imply that the steps are performed in any given order. As an illustrative example, with reference to FIG. 3, step 305 may be performed before, after or in parallel with step 310.

The example embodiments described above can be implemented in many ways, such as program instructions for execution by a processor, as logic circuits, as an application specific integrated circuit, as firmware, etc. For example, the embodiments can be implemented as one or more software or firmware applications, computer-implemented methods, program products stored on a computer useable medium, for execution on one or more processors (e.g., CPU, microcontroller) or other computing devices in a wireless station.

The above embodiments are to be understood as illustrative examples of the invention. Further embodiments of the invention are envisaged. For example, the database may be known as an Electronic Medical Record (EMR), Electronic Health Record (HER), Practice Management System, or health information system. Further, there may be multiple databases, for example in different practices, each may comprise medical data for different patients such that when used in combination they fulfil the role of the single database described above. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, several embodiments of which are defined in the accompanying claims.

What is claimed is:

1. A method of processing clinical data, the method comprising configuring at least one processor and at least one memory including computer program instructions to perform the steps of:
receiving an identity of a patient;
conducting a patient consultation session using a point of care computing device, the patient consultation session comprising:
transmitting the identity of the patient to a database adapted to store clinical data, the clinical data comprising at least data corresponding to a clinical intervention program;
receiving first data relating to a said clinical intervention program for the patient from the database;
outputting the first data to a display of the point of care computing device; and
determining second data indicative of an action taken in response to the outputting of the data, wherein the second data is for transmission to the database.

2. The method of claim 1, wherein the patient is identified by a facial recognition algorithm.

3. The method of claim 1, wherein the facial recognition algorithm is performed by the point of care computing device on a digital image of the patient, the digital image being captured by a camera operatively connected to or contained within the point of care computing device.

4. The method of claim 1, wherein the point of care computing device is a wearable computing device.

5. The method of claim 1, wherein the first data is output as human-comprehensible speech.

6. The method of claim 1, wherein the determining second data comprises:
recording input comprising human speech including information;
encoding the recorded human speech;
inputting the encoded human speech to a speech recognition algorithm;
executing the speech recognition algorithm, whereby to generate an output based on the recorded human speech; and
generating the second data from the output of the speech recognition algorithm.

7. The method of claim 1, wherein the clinical intervention program comprises a recommended medical intervention selected according to clinical quality measures.

8. The method of claim 7, wherein the second data comprises at least an indication of whether the recommended medical intervention was followed.

9. The method of claim 8, including configuring the point of care computing device to output a request for confirmation of whether the recommended medical intervention was followed, the request being issued subsequent to outputting the first data.

10. A non-transitory computer-readable storage medium comprising a set of computer-readable instructions stored thereon, which, when executed by at least one processor, cause the at least one processor to:
receive an identity of a patient;
conduct a patient consultation session using a point of care computing device, the patient consultation session comprising:
transmitting the identity of the patient to a database adapted to store clinical data, the clinical data comprising at least data corresponding to a clinical intervention program;
receiving first data relating to a said clinical intervention program for the patient from the database;
outputting the first data to a display of the point of care computing device; and
determining second data indicative of an action taken in response to the outputting of the data, wherein the second data is for transmission to the database.

11. An apparatus comprising:
at least one processor; and
at least one memory including computer program instructions;
the at least one memory and the computer program instructions being configured to, with the at least one processor, cause the apparatus at least to:
receive an identity of a patient;
conduct a patient consultation session using a point of care computing device, the patient consultation session comprising:
transmitting the identity of the patient to a database adapted to store clinical data, the clinical data comprising at least data corresponding to a clinical intervention program;
receiving first data relating to a said clinical intervention program for the patient from the database;
outputting the first data to a display of the point of care computing device; and
determining second data indicative of an action taken in response to the outputting of the data, wherein the second data is for transmission to the database.
